(19) United States
(12) Patent Application Publication
(10) Pub. No.: US 2008/0071017 A1
(43) Pub. Date: Mar. 20, 2008

(54) Anhydride-Functional Silsesquioxane Resins

(76) Inventors: Glenn Viaplana Gordon, Midland, MI (US); Randall Gene Schmidt, Midland, MI (US); Gary Michael Wieber, Midland, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 11/661,907

(22) PCT Filed: Aug. 30, 2005
(86) PCT No.: PCT/US05/30840

§ 371 Date: Mar. 2, 2007

Related U.S. Application Data
(60) Provisional application No. 60/609,166, filed on Sep. 10, 2004.
(60) Provisional application No. 60/614,249, filed on Sep. 29, 2004.

(51) Int. Cl. C08G 77/00; C08K 3/10

(52) U.S. Cl. 524/437; 524/451; 524/588; 525/476; 528/40

(57) ABSTRACT

An anhydride functional silsesquioxane resin composition containing the units:
(R¹₃SiO_{1/2})ₐ (i)
(R²₂SiO_{2/2})_{b} (ii)
(R³SiO_{3/2})_{c} and (iii)
(SiO_{4/2})_{d}. (iv)
R¹, R², and R³ can be an anhydride group, a hydrogen atom, an alkyl group, an aryl group, an aralkyl group, or an alkaryl group. a is 0.1-0.6, b is zero to 0.5, c is 0.3-0.8, d is zero to 0.3, and the sum of a, b, c, and d, is one. The composition contains more than two anhydride groups. The anhydride functional silsesquioxane resin can be used to form curable one-part composition containing the anhydride functional silsesquioxane resin composition, an epoxy resin; and optionally, an anhydride containing organic curing agent, a cure accelerator, and a filler.

This invention is directed to anhydride functional silsesquioxane resins and to hybrid compositions containing the anhydride functional silsesquioxane resins and epoxy resins. In the latter, the anhydride functional silsesquioxane resins can be co-reacted with the epoxy resins in one-part delivery systems to obtain tough, high temperature-resistant thermosetting compositions having an organopolysiloxane content of 5-80 percent by weight.

Siloxane resins have exceptional thermal stability and weatherability including low water absorption. However, their poor toughness, adhesion, and dimensional stability, i.e., low glass transition temperature (Tg) and high coefficient of thermal expansion (CTE), limit their utility. Epoxy resins however exhibit very good toughness, solvent resistance, adhesion and dimensional stability, but suffer from marginal thermal stability and weatherability.

While anhydride functional linear siloxanes are known, i.e., U.S. Pat. No. 5,117,001 (May 26, 1992), anhydride functional silsesquioxane resins are not known, nor are hybrid compositions containing anhydride functional silsesquioxane resin and epoxy resins known. According to the present invention therefore, it was found that certain anhydride functional silsesquioxane resins are capable of providing capability to achieve properties including higher thermal stability in one-part delivery systems that is greatly preferred in the electronic industries for example.

The symbols M, D, T, and Q are used to represent the functionality of the structural units of the organosilicon resins herein in accordance with their established understanding in the silicone industry. Thus, M represents the monofunctional unit R₃SiO_{1/2}; D represents the difunctional unit R₂SiO_{2/2}; T represents the trifunctional unit RSiO_{3/2}; and Q represents the tetrafunctional unit SiO_{4/2}. The structural formula of each of these units is shown below.

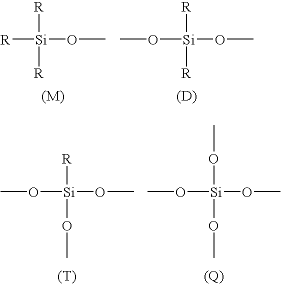

Since the compositions herein contain a high proportion of T units that can combine with one another, this results in molecules that are linked forming three dimensional structures. These so-called silsesquioxanes are small cage-like or ladder polymers with four, six, eight and twelve or more siloxane units, and generally conform to the formula [RSiO_{3/2}]n. Typically, n has a value of four or more.

By way of illustration, and not being bound by it, when n is eight for example, the bond arrangement for a silsesquioxane cubical octamer results, having a structure such as is depicted below.

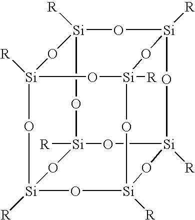

As the series is extended, i.e., n having a value of five or more, double-stranded polysiloxanes of indefinitely higher molecular weight can be formed that contain regular and repeated connections in an extended structure. Typically, the R groups in these molecules can be the same or different.

The present invention relates to an anhydride functional silsesquioxane resin composition. It generally contains units of the formulae:
(R¹₃SiO_{1/2})ₐ (i)
(R²₂SiO_{2/2})_{b} (ii)
(R³SiO_{3/2})_{c} and (iii)
(SiO_{4/2})_{d}. (iv)

In the formulae (i)-(iv), R¹, R², and R³ can each independently represent an anhydride group, a hydrogen atom, an alkyl group having 1-8 carbon atoms, an aryl group, an aralkyl group, or an alkaryl group. It is preferred that R³ does not represent an anhydride group. The value of a is 0.1-0.6. The value of b is zero to 0.5. The value of c is 0.3-0.8. The value of d is zero to 0.3. Preferably, a is 0.2-0.4, b is zero to 0.2, c is 0.5-0.8, and d is zero. The sum of a, b, c, and d, is one. The composition of an average resin molecule contains more than two anhydride groups.

The invention also relates to a curable one-part composition containing (A) 100 parts by weight of the anhydride functional silsesquioxane resin composition noted above; (B) 20-2,000 parts by weight of an epoxy resin containing at least two epoxide rings per molecule; (C) 0-100 parts by weight of an anhydride containing organic curing agent; and (D) 0-5 parts by weight of a cure accelerator; with the proviso that the ratio of total anhydride to epoxide ring is 0.5:1 to 1.0:1, preferably 0.75:10. If desired, the curable one-part composition may also contain (E) up to 50 weight percent filler. Preferably, the amount of (B) is 30-500 parts by weight, (C) is zero to 20 parts by weight, and (D) is 0.5-3 parts by weight, in each case based on 100 parts by weight of (A).

Representative of a suitable anhydride group, and the preferred anhydride group is the tetrahydrophthalic anhydride group shown below.

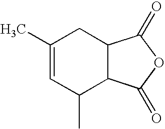

Suitable alkyl groups include methyl, ethyl, propyl, butyl, and octyl groups. A suitable aryl group is phenyl. The aralkyl group can include benzyl, phenylethyl, and 2-phenylpropyl. The alkaryl group can be tolyl or xylyl.

Some representative examples of epoxy resins that may be used include bisphenol-A/epichlorohydrin resins such as diglycidyl ethers of bisphenol-A and their hydrogenated analogs, epoxy novolac resins, cycloaliphatic epoxy resins, and alicyclic diepoxy carboxylate resins. These epoxy resins are known in the art and commercially available from vendors such as The Dow Chemical Company, Midland, Mich., for example, as DER 331 (a bisphenol-A/epichlorohydrin resin), Cyracure 6105 (a cycloaliphatic epoxide resin), and DEN 431 (an epoxy novolac resin).

Some anhydride containing organic curing agents that can be used include phthalic anhydride, hexahydrophthalic anhydride, tetrahydrophthalic anhydride, methyltetrahydrophthalic anhydride, and dodecylsuccinic anhydride. The cure accelerator can be an imidazole, a substituted guanidine, a diorganosulfoxide, an amidine, a tertiary amine or an amine. Some suitable imidazoles include 2-methyl imidazole, N-methyl-2-methyl imidazole, 2-ethyl-4-methylimidizole, and benzimidazole. Some suitable diorganosulfoxides include dimethylsulfoxide, methylethylsulfoxide, and diphenylsulfoxide. Some suitable amidines include N,N-dimethylbenzamidine and diphenylacetamidine. Some suitable amines include di-n-hexylamine, dicyclohexylamine, d-n-octylamine, dicyclopentylamine, and di-t-butylethylene diamine.

Some suitable fillers that can be used include fumed silica, precipitated silica, silica gel, silica, diatomaceous earth, talc, crushed quartz, ground quartz, alumina, titanium dioxide, glass fibers, calcium carbonate, iron oxide, carbon black, graphite, or hollow microspheres.

The following examples are set forth in order to illustrate the invention in more detail. The examples relate to the preparation of anhydride functional silsesquioxane resins and hybrid compositions of the anhydride functional silsesquioxane resins with epoxy resins. In the examples, anhydride functional silsesquioxane resins 1 and 2 were prepared by first preparing a SiH functional resin intermediate. This was followed by hydrosilation of the SiH functional resin intermediate with 2-methyl-3-butyn-2-ol (HC═CC(CH₃)₂OH), dehydration to form a diene functionality, and Diels-Alder addition of maleic anhydride. 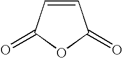
Maleic Anhydride

The reaction is carried out in a solvent such as benzene, toluene, xylene, tetrahydrofuran, diethylether, at a temperature of −50° C. to 100° C. The reaction is carried out typically in 30 minutes to 24 hours, generally in 6-12 hours. The ratio of the amount of maleic anhydride used to the amount of the SiH functional resin intermediate is from 1:0.1 to 1:2.5 on a molar basis, generally from 1:0.2 to 1:1.5.

Hydrosilation requires a catalyst to effect reaction between the ≡SiH containing reactant and the reactant containing unsaturation. Suitable catalysts are Group VIII transition metals. Some examples of metal catalysts that can be used are platinum catalysts resulting from reaction of chloroplatinic acid with organosilicon compounds containing terminal aliphatic unsaturation described in U.S. Pat. No. 3,419,593 (Dec. 31, 1968); Karstedt's catalyst described in his U.S. Pat. No. 3,715,334 (Feb. 6, 1973) and U.S. Pat. No. 3,814,730 (Jun. 4, 1974) which is a platinum-vinylsiloxane substantially free of chemically combined halogen; deposited platinum catalysts and complexed platinum catalysts described in U.S. Pat. No. 3,923,705 (Dec. 2, 1975); platinum-organopolysiloxane complexes prepared by reacting platinous halides with organopolysiloxanes having silicon bonded organic groups containing terminal olefinic unsaturation described in U.S. Pat. No. 5,175,325 (Dec. 29, 1992); and platinum supported on active carbon particles.

### EXAMPLES

### Example 1

### Preparation of SiH Functional Resin Intermediate A

Phenyltrimethoxysilane C₆H₅Si(OCH₃)₃ (4,752 gram) catalyzed by trifluoromethane sulfonic acid (TFMSA, 2.2 gram) was hydrolyzed with deionized water (500.96 gram), followed by distillation and removal of by-product methanol. 1,1,3,3-tetramethyl-1,3-disiloxane (TMDS) (1,316.4 gram) and acetic acid (588.6 gram) were added, and the mixture was heated to 50° C. for three hours. Methanol and methyl acetate were removed by distillation. Heptane (1,300 gram) was added, the mixture was washed with saturated aqueous sodium bicarbonate (3,000 gram) and then with deionized water (1,500 gram), and the organic phase was filtered. Additional washing with deionized water (2×1,500 gram), and removal of the solvent under vacuum, yielded 4,051.6 gram of a liquid product with a ²⁹Si NMR determined composition of M^{H}_{0.42}T^{Ph}_{0.58} where M^{H} is H(CH₃)₂SiO_{1/2} and T^{Ph} is C₆H₅SiO_{3/2}.

### Example 2

### Preparation of Anhydride Functional Silsesquioxane Resin 1

A mixture of 2-methyl-3-butyn-2-ol (48.18 gram) and 0.84 gram of a toluene solution containing 0.481 percent by weight of platinum catalyst in the form of platinum(divinyltetramethyldisiloxane)₂ was heated to 90° C., then a mixture of the SiH functional resin intermediate A prepared in Example 1 (100.09 gram) dissolved in xylene (42.74 gram), was added drop wise. After heating the mixture at 90-100° C. for 70 minutes, the solvent was removed under vacuum. The product was dissolved in xylene (300.4 gram), and potassium hydrogen sulfate (3.08 gram) was added. The mixture was heated to remove water as an azeotrope by holding the reflux temperature for four hours. The mixture was filtered. Maleic anhydride (73.5 gram) was added, and the mixture was heated to reflux for 24 hours. The total moles of anhydride to moles of SiH was 1:0.54. The solvent was removed from the mixture, and the mixture was re-dissolved in toluene (122.77 gram), and then filtered. The yield was 237.1 gram of a 45 percent by weight solution containing a composition determined by ²⁹Si NMR to be M^{R}_{0.38}T^{Ph}_{0.62}. The composition consisted of two isomers. The M^{R} unit was tetrahydrophthalic anhydride (CH₃)₂SiO_{1/2} and the T^{Ph} unit was C₆H₅SiO_{3/2}. The M^{R} unit for the major isomer is shown in more detail below.

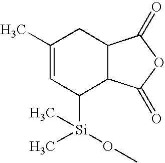

### Example 3

### Preparation of SiH Functional Resin Intermediate B

Methyltrimethoxysilane CH₃Si(OCH₃)₃ (4,958.4 gram) was hydrolyzed with deionized water (252.3 gram) in the presence of trifluoromethane sulfonic acid (4.93 gram). 1,1,3,3-tetramethyl-1,3-disiloxane (TMDS) (5,456.4 gram) and additional deionized water (725.8 gram) were added. The volatile content was removed by distillation, and then the product mixture was dissolved in hexane (2,210 gram). The product solution was washed with saturated aqueous sodium bicarbonate and multiple aliquots of deionized water. It was then dried over magnesium sulfate, filtered, and any remaining solvent was removed. The product had a ²⁹Si NMR determined composition of M^{H}_{0.52}T^{Me}_{0.48} where M^{H} is H(CH₃)₂SiO_{1/2} and T^{Me} is CH₃SiO_{3/2}.

### Example 4

### Preparation of Anhydride Functional Silsesquioxane Resin 2

A mixture of 2-methyl-3-butyn-2-ol (200.35 gram) and 0.51 gram of a toluene solution containing 0.481 percent by weight of platinum catalyst in the form of platinum (divinyltetramethyldisiloxane)₂ was heated to 95° C. A mixture of the SiH functional resin intermediate B (200.17 gram) prepared in Example 3 was dissolved in xylene (86.04 gram), and added to the solution drop wise. After heating the mixture at 90-100° C. for 8.5 hours, the solvent was removed under vacuum. The product was dissolved in xylene (300.0 gram), and potassium hydrogen sulfate (4.01 gram) added. The mixture was heated to remove water as an azeotrope by holding the reflux temperature for eighteen hours. Maleic anhydride (313.1 gram) was added, and the mixture was heated to reflux for 48 hours. The total moles of anhydride to moles of SiH was 1:0.49. The solvent was removed under vacuum. The product was re-dissolved in toluene (491.4 gram) and filtered. The toluene was stripped yielding 415.5 gram of a viscous amber liquid. The liquid product had a ²⁹Si NMR spectrum containing major peaks centered at chemical shifts (relative to 0 ppm for tetramethylsilane) of 7 ppm (0.21 mol fraction, M^{R}), −20 ppm (0.29 mol fraction (CH₃)₂SiO_{2/2}, and −66 ppm (0.40 mol fraction, CH₃SiO_{3/2}). The unit M^{R} was tetrahydrophthalic anhydride, shown in more detail below.

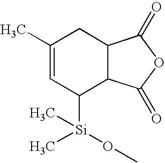

In the following additional examples, two test methods were used to evaluate the performance characteristics of the materials prepared in the above examples. The protocol of each test method is set forth below.

Thermogravimetric Analysis

A thermogravimetric analysis was performed using a Model TGA 2950 instrument manufactured by TA Instruments, New Castle, Del. Approximately 7-12 milligram of a single piece of the test specimen was placed in a platinum pan and heated to 1,000° C. at a rate of 10° C./minute under an air atmosphere. The weight loss was continuously monitored and recorded. The weight loss at 400° C. was reported. The uncertainty was estimated to be plus or minus 5 percent based on duplicate analysis.

Dynamic Mechanical Thermal Analysis

Dynamic mechanical thermal analysis was conducted using a Rheometric Scientific Model RDAII instrument obtained from TA Instruments, New Castle, Del. The instrument was equipped with rectangular torsion fixtures. Rectangular test specimens were cut such that thickness ranged from 1.4-1.6 millimeter, the width was between 6-7 millimeter, and the free length was from 24-28 millimeter. A dynamic frequency of 1 Hz and a heating rate of 2° C./minute were applied. A strain sweep was conducted at the starting temperature of −102° C. to determine an appropriate strain to measure the linear viscoelastic properties. The dynamic strain ranged from 0.012-0.040 percent. The autostrain in 5 percent increments and the autotension options were used. The tool expansion was based on 2.12 μm/° C. The shear storage modulus at 25° C. was reported.

In the examples below, the materials used included DER 331, Lindride® 12, and Shell 1202 Accelerator. DER 331 is a liquid epoxy resin formed by the reaction of epichlorohydrin and bisphenol-A. It is the diglycidyl ether of bisphenol-A sold by The Dow Chemical Company, Midland, Mich. Lindride® 12 is a methyltetrahydropthalic anhydride curing agent sold by Lindau Chemical Company, Columbia, S.C. Shell 1202 Accelerator is the compound 2-methylimidazole sold by Shell Chemical Company, Houston, Tex.

Control 1

1.77 gram of Lindride 12 anhydride curing agent was added to 2.0 gram of DER 331 in a one ounce glass vial using a 5 milliliter syringe providing a 1:1 stoichiometric ratio. The materials were mixed at room temperature using a wooden stirring rod. This light tan, transparent mixture, was cured in a thin aluminum mold in a nitrogen purged laboratory oven for one hour at 100° C., followed by one hour each at 150° C. and 200° C. It was then slowly cooled to 30° C. A tacky solid resulted, so the material was cured for an additional 12 hours at 205° C. The result was a rigid, light yellow, transparent disk with good adhesion to the thin aluminum mold. The thin aluminum mold was peeled from the sample, and the material was machined to provide a rectangular sample for evaluation by dynamic mechanical thermal analysis (DMTA) and thermal analysis. The results are shown in Table 1.

Control 2

1.77 gram of a blend containing 2 percent by weight Shell 1202 accelerator and Lindride 12 anhydride curing agent, was added to 2.0 gram of DER 331 in a one ounce glass vial using a 5 milliliter syringe providing a 1:1 mole anhydride to mole epoxy group ratio. The materials were mixed at room temperature using a wooden stirring rod. This yellow, transparent mixture was cured in a thin aluminum mold in a nitrogen purged laboratory oven for one hour at 100° C. followed by one hour each at 150° C. and 200° C. It was then slowly cooled to 30° C. A rigid, solid, amber, transparent disk with good adhesion to the thin aluminum mold resulted. The thin aluminum mold was peeled from the sample, and the material was machined to provide a rectangular sample for evaluation by dynamic mechanical thermal analysis (DMTA) and thermal analysis. The results are shown in Table 1.

### Example 5

2 gram of the anhydride functional silsesquioxane resin 2 prepared in Example 4 were syringed into a small circular aluminum mold. 1.3 gram of DER 331 was added using a 5 milliliter syringe providing a 1:1 moles anhydride to moles epoxy groups ratio. The materials were mixed at room temperature using a wooden stirring rod. This transparent, amber mixture was cured in a nitrogen purged laboratory oven for one hour at 100° C. followed by one hour each at 150° C. and 200° C. It was then slowly cooled to 30° C. A rigid, solid, amber, transparent disk with good adhesion to the aluminum mold resulted. The thin aluminum mold was peeled from the sample, and the material was machined to provide a rectangular sample for evaluation by dynamic mechanical thermal analysis (DMTA) and thermal weight loss analysis. The results are shown in Table 1.

### Example 6

2 gram of the anhydride functional silsesquioxane resin 2 used in Example 5 were syringed into a small circular aluminum mold. 1.3 gram of DER 331 was added using a 5 milliliter syringe providing a 1:1 mole anhydride to mole epoxy group ratio. 0.1 gram of a Lindride 12 solution containing 2 percent by weight of 2-methylimidazole cure accelerator was incorporated by extensive mixing at room temperature using a wooden stirring rod. This translucent, amber mixture was cured in a nitrogen purged laboratory oven for one hour at 100° C. followed by 1 hour each at 150° C. and 200° C. It was then slowly cooled to 30° C. A rigid, solid, amber, hazy disk with good adhesion to the aluminum mold resulted.

### Example 7

4 gram of the anhydride functional silsesquioxane resin 1 prepared in Example 2 as a 45 percent by weight solids solution in butyl acetate, were weighed into a small circular aluminum mold. 0.65 gram of DER 331 was added using a 5 milliliter syringe. 0.1 gram of a Lindride 12 solution containing 2 weight percent of Shell 1202 accelerator was added. The three components were mixed at room temperature using a wooden stirring rod. This amber mixture was cured in a nitrogen purged laboratory oven for one hour at 120° C. to remove the solvent, followed by 4 hours at 165° C. and 12 hours at 200° C. It was then slowly cooled to 30° C. A rigid, solid, amber, hazy disk with good adhesion to the aluminum mold resulted. The aluminum mold was peeled from the sample followed by thermal analysis. The results are shown in Table 1.

TABLE 1

| | 25° C. | Plateau | | Wt Loss at | |
|---|---|---|---|---|---|
| | Modulus | Modulus | | 400° C. | |
| | G′ (GPa) | G_{N} (MPa) | T_{g} | (air) | Observation |
| Example 5 | 0.8 | 16.3 | 141 | 22.1 | Transparent |
| | | | | | amber, rigid |
| Example 7 | | | | 19.0 | Hazy, amber, |
| | | | | | rigid |
| Control 1 | | | | 44.5 | Transparent, |
| | | | | | light yellow, |
| | | | | | rigid |
| Control 2 | 1.1 | 8.0 | 135 | 42.8 | Transparent, |
| | | | | | amber, rigid |

Table 1 shows that by using the anhydride functional silsesquioxane resins according to the invention in place of organic anhydride materials reduces the weight loss in air at 400° C. by 48-57 percent while maintaining similar dynamic mechanical properties.

### Example 8

2 gram of the anhydride functional silsesquioxane resin 2 used in Example 5 was syringed into a small circular aluminum mold. 1.3 gram of DER 331 was added using a 5 milliliter syringe and the materials were mixed at room temperature using a wooden stirring rod. This high viscosity liquid was loaded into a polypropylene syringe and placed in a refrigerator for 3 months. After three months storage, the material was warmed to room temperature and dispensed from the syringe into an aluminum pan mold. The material was cured for one hour at 100, 150 and 200° C., and resulted in a rigid, amber, transparent monolithic cured sample with strong adhesion to the aluminum mold. This example demonstrated the utility of the anhydride functional silsesquioxane resin/epoxy hybrid compositions of the invention as one-part systems for storage and delivery as an adhesive or an encapsulant. For example, such compositions can be used as adhesives for bonding two similar or different substrates to one another, including difficult to adhere substrates such as low energy plastics. As an encapsulant, the compositions can be used to protect electronic and optical components.

Other variations may be made in compounds, compositions, and methods described herein without departing from the essential features of the invention. The embodiments of the invention specifically illustrated herein are exemplary only and not intended as limitations on their scope except as defined in the appended claims.

1. An anhydride functional silsesquioxane resin composition comprising units of the formulae:
(R¹₃SiO_{1/2})ₐ (i)
(R²₂SiO_{2/2})_{b} (ii)
(R³SiO_{3/2})_{c} and (iii)
(SiO_{4/2})_{d}. (iv)
where R¹, R², and R³ are each independently an anhydride group, a hydrogen atom, an alkyl group having 1-8 carbon atoms, an aryl group, an aralkyl group, or an alkaryl group; a has a value of 0.1-0.6; b has a value of zero to 0.5; c has a value of 0.3-0.8; d has a value of zero to 0.3; the sum of a, b, c, and d, is one; with the proviso that the composition contains on average more than two anhydride groups per average molecule.

2. A composition according to claim 1 wherein the anhydride functional silsesquioxane resin comprises only (R¹₃SiO_{1/2})ₐ and (R³SiO_{3/2})_{c} units, and wherein a, c, R¹ and R³ are the same as defined in claim 1.

3. A composition according to claim 1 wherein the anhydride group is tetrahydrophthalic anhydride.

4. A composition according to claim 1 wherein R³ is not an anhydride group.

5. A curable one-part composition comprising (A) 100 parts by weight of the anhydride functional silsesquioxane resin composition according to any of claims 1-4; (B) 20-2,000 parts by weight of an epoxy resin containing at least two epoxide rings per molecule; (C) 0-100 parts by weight of an anhydride containing organic curing agent; and (D) 0-5 parts by weight of a cure accelerator; with the proviso that the total anhydride to epoxide ring ratio is 0.5:1 to 1.0:1

6. A curable one-part composition according to claim 5 further comprising (E) a filler.

7. A curable one-part composition according to claim 5 in which the epoxy resin is a bisphenol-A/epichlorohydrin resin, an epoxy novolac resin, a cycloaliphatic epoxy resin, or an alicyclic diepoxy carboxylate resin.

8. A curable one-part composition according to claim 5 in which the anhydride containing organic curing agent is phthalic anhydride, hexahydrophthalic anhydride, tetrahydrophthalic anhydride, methyltetrahydrophthalic anhydride, or dodecylsuccinic anhydride.

9. A curable one-part composition according to claim 5 in which the cure accelerator is an imidazole, a substituted guanidine, a diorganosulfoxide, an amidine, a tertiary amine, or an amine.

10. A curable one-part composition according to claim 6 in which the filler is selected from the group consisting of fumed silica, precipitated silica, silica gel, silica, diatomaceous earth, talc, crushed quartz, ground quartz, alumina, titanium dioxide, glass fibers, calcium carbonate, iron oxide, carbon black, graphite, and hollow microspheres

11. A curable one-part composition according to claim 5 in which the total anhydride to epoxide ring ratio is 0.75:1.

12. A method of bonding two similar substrates or two different substrates to one another comprising applying to at least one surface of the substrate the curable one-part composition according to claim 5.

12. (canceled)

13. A method of encapsulating an electronic component or optical component comprising applying to the component the curable one-part composition according to claim 5.

14. A composition according to claim 2 wherein the anhydride group is tetrahydrophthalic anhydride.

15. A composition according to claim 14 wherein R³ is not an anhydride group.

16. A method of bonding two similar substrates or two different substrates to one another comprising applying to at least one surface of the substrate the curable one-part composition according to claim 11.

17. A method of encapsulating an electronic component or optical component comprising applying to the component the curable one-part composition according to claim 11.
